(19) United States
(12) Patent Application Publication
(10) Pub. No.: US 2004/0021298 A1
(43) Pub. Date: Feb. 5, 2004

(54) Foldable wheel chair

(76) Inventor: Ruey Yun Tsai, Taichung (TW)

Correspondence Address: RUEY YUN TSAI, No. 1, Alley 16, Lane 40, Jinn Te Road, Taichung, TW

(21) Appl. No.: 10/212,587

(22) Filed: Aug. 2, 2002

(51) Int. Cl. B62B 1/00

(52) U.S. Cl. 280/642

(57) ABSTRACT

A wheel chair includes two side frames and a cross assembly is pivotably connected between the two side frames. The cross assembly includes two parts and each part includes a top tube, a bottom tube and a link connected between the top tube and the bottom tube. The link includes a first section extending from the top tube, a second section extending from the bottom tube and a third section which has two ends respectively pivotably connected to the first section and the second section. When folding the wheel chair, the cross assembly can be further folded to reduce the final height of the wheel chair.

### FIELD OF THE INVENTION

The present invention relates to a foldable wheel chair wherein each tube of the foldable cross assembly can be further foldable so as to reduce the height after the wheel chair is folded.

### BACKGROUND OF THE INVENTION

A conventional frame of wheel chair is shown in FIGS. 1 and 2, and generally includes two side frames 30, 40 and a cross assembly pivotably connected between the two side frames 30, 40. A seat (not shown) generally made of flexible fabric is connected between two sides of the cross assembly and two wheels (not shown) are connected to the two side frames 30, 40 respectively. The cross assembly includes two parts 10, 20 which are pivotably connected with each other at an intermediate portion thereof and each part 10/20 has a top tube and a bottom tube between which two links are connected. Each of the two side frames 30, 40 has two support members 32, 42 connected thereto so that the two top tubes of the two parts 10, 20 are supported on the two support members 32, 42. The two respective bottom tubes 11, 21 are engaged with the engaging ports 41, 41 on the two parts 30, 40. When folding the wheel chair, the cross assembly is folded at the pivotable positions and the two top tubes are removed from the support members 32, 42 so that the two side frames 30, 40 are able to be pulled toward each other. The final height of the wheel chair starts from the top tubes of the two parts 10, 20 to the ground. Even if the diameter of the wheels are not included as shown in FIG. 4, the height of the two parts 10, 20 plays a main role in the final height of the folded wheel chair. The folded wheel chair cannot be put in a trunk of a sedan and this is inconvenient for the users to carry by vehicles.

The present invention intends to provide an improved frame for a wheel chair and the frame can be further folded to effectively reduce the final height of the folded wheel chair.

### SUMMARY OF THE INVENTION

In accordance with one aspect of the present invention, there is provided a wheel chair which comprises two side frames and a cross assembly is pivotably connected between the two side frames. The cross assembly includes two parts and each part comprises a top tube, a bottom tube and a link connected between the top tube and the bottom tube. The link comprises a first section extending from the top tube, a second section extending from the bottom tube and a third section which has two ends respectively pivotably connected to the first section and the second section.

The primary object of the present invention is to provide a wheel chair that has a cross assembly between two side frames and the cross section can be further folded to reduce the final height of the wheel chair.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a conventional frame of a wheel chair;

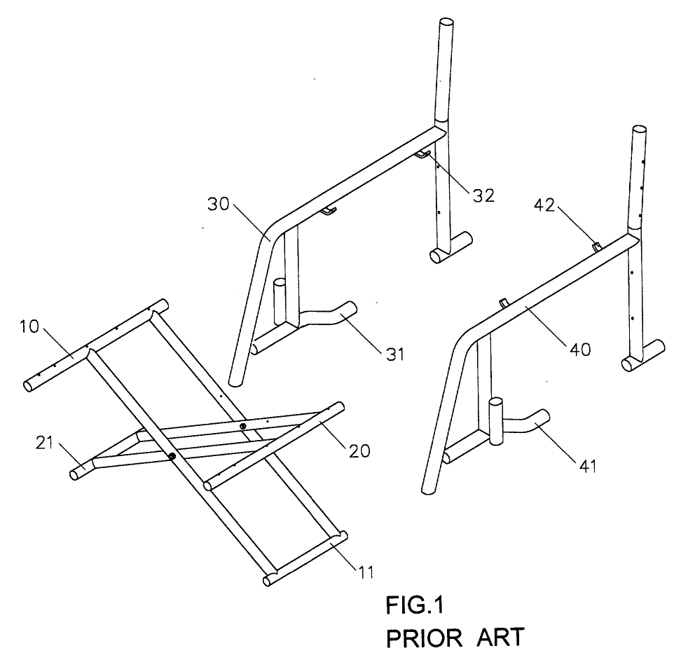

FIG. 2 is a perspective view to show the conventional wheel chair;

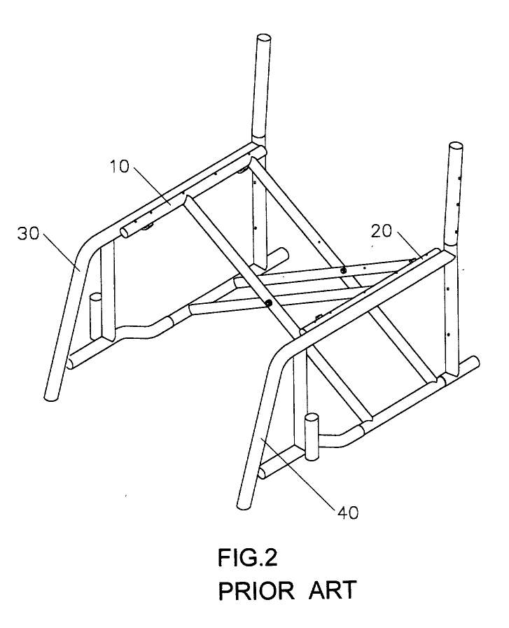

FIG. 3 shows the folded conventional wheel chair;

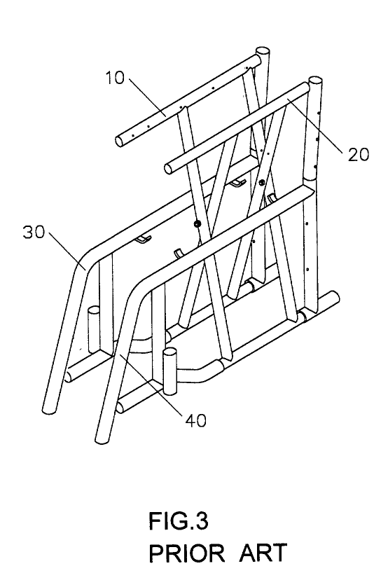

FIG. 4 shows the height of the folded cross assembly of the conventional wheel chair;

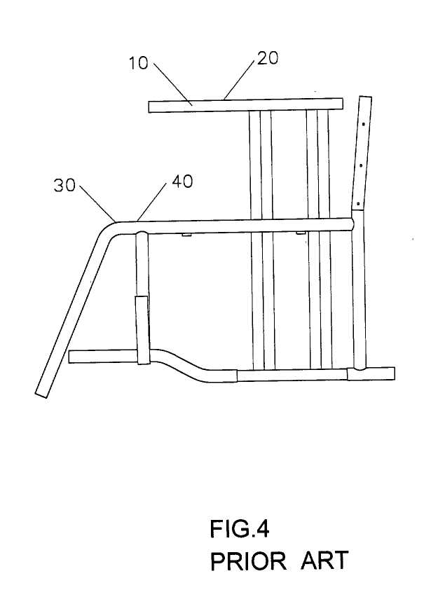

FIG. 5 is a perspective view to show one of the two identical parts of the cross assembly of the frame of the wheel chair of the present invention;

FIG. 6 is an exploded view to show the each part of the cross assembly of the present invention;

FIG. 7 shows the frame of the wheel chair of the present invention;

FIG. 8 shows the part of the present invention is further folded;

FIG. 9 shows the folded wheel chair wherein the cross assembly is further folded, and

FIG. 10 shows that the upright post of the side frames is folded to reduce the final height of the folded wheel chair.

### DETAILED DESCRIPTION OF THE PREFERRED EMBODIMENT

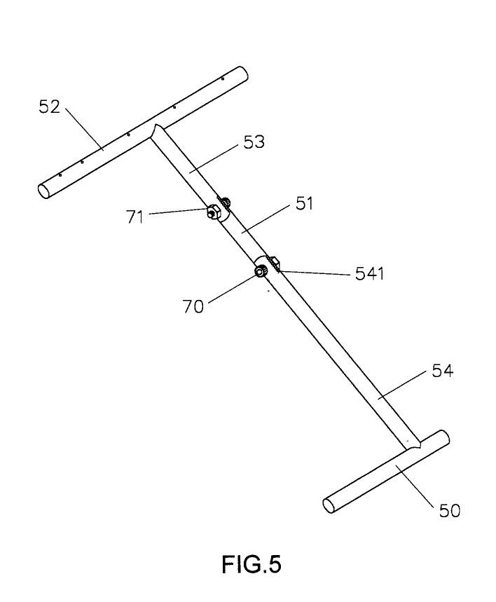

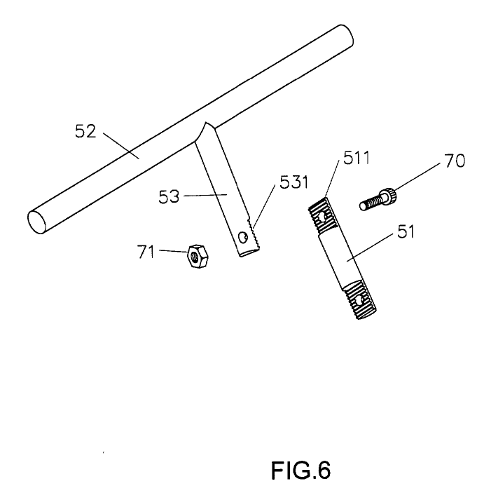

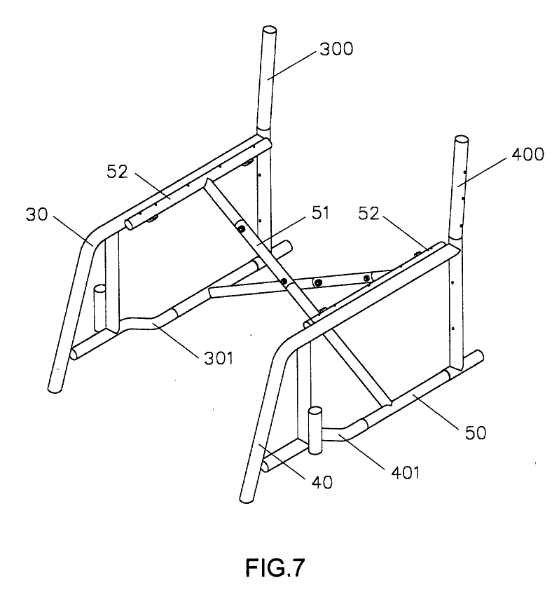

Referring to FIGS. 5 to 7, the wheel chair of the present invention comprises a first side frame 30 and a second side frame 40, a cross assembly is pivotably connected between the first side frame 30 and the second side frame 40. Each of the first side frame 30 and the second side frame 40 includes an upright post 300/400 which is connected to a handle (not shown) and two wheels (not shown) are connected to outside of the two side frames 30 and 40.

The cross assembly includes two parts and each part comprises a top tube 52, a bottom tube 50 and a link connected between the top tube 52 and the bottom tube 50. The two links are pivotably connected with each other at an intermediate portion thereof. The bottom tubes 50 are pivotably connected to two engaging ports 301, 401 of the two side frames 30 and 40. The link comprises a first section 53 extending from the top tube 52, a second section 54 extending from the bottom tube 50 and a third section 51 which has two ends respectively pivotably connected to the first section 53 and the second section 54.

Each of the first side frame 30 and the second side frame 40 has support members and the top tubes 52 of the two parts are supported on the support members of the first side frame 30 and the second side frame 40. A seat made of flexible fabric (not shown) is connected between two top tubes 52, 52.

A distal end of the first section 53 has a first toothed surface 531 and the third section 51 has a toothed surface 511 defined in each one of the two ends thereof. The first toothed surface 531 is matched with the toothed surface 511 of the third section 51 and a screw 70 extends through the first toothed surface 531 and the toothed section 511 of the third section 51, and is locked to a nut 71.

A distal end of the second section 54 has a second toothed surface 541 which is matched with the other toothed surface 511 of the third section 51. A screw 70 extending through the second toothed surface 541 and the toothed section 511 of the third section 51.

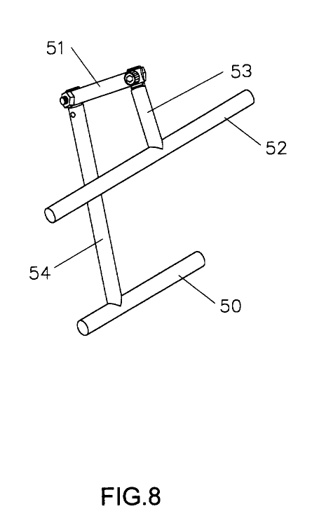

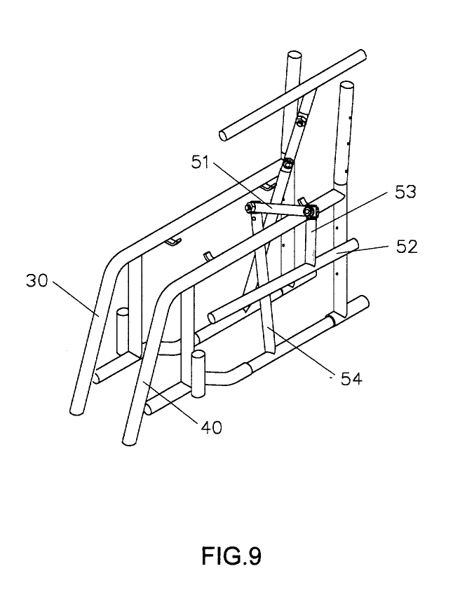

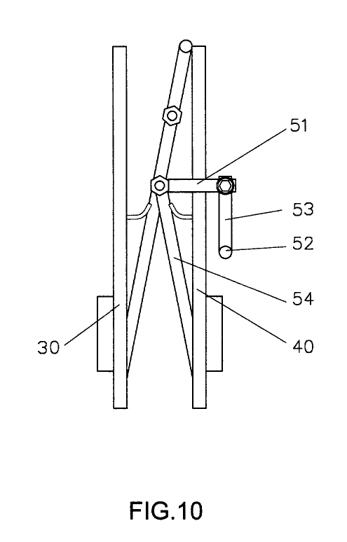

Referring to FIGS. 8 and 9, when folding the wheel chair, the cross assembly is folded to pull the two side frames 30 and 40 toward each other. The top tube 52 and the first section 53 are pivoted about the screw 70 and the third section 51 is pivoted about the other screw 70 to further shorten the length of the cross assembly. The upright posts 300 and 400 may be designed to be folded as shown in FIG. 10 so that the final height of the wheel chair can be further reduced.

While we have shown and described the embodiment in accordance with the present invention, it should be clear to those skilled in the art that further embodiments may be made without departing from the scope of the present invention.

What is claimed is:

1. A wheel chair comprising:
a first side frame and a second side frame, a cross assembly pivotably connected between the first side frame and the second side frame, the cross assembly including two parts and each part comprising a top tube, a bottom tube and a link connected between the top tube and the bottom tube, the two links pivotably connected with each other at an intermediate portion thereof, the link comprising a first section extending from the top tube, a second section extending from the bottom tube and a third section which has two ends respectively pivotably connected to the first section and the second section.

2. The wheel chair as claimed in claim 1, wherein each of the first side frame and the second side frame has support members and the top tubes are supported on the support members of the first side frame and the second side frame.

3. The wheel chair as claimed in claim 1, wherein a distal end of the first section has a first toothed surface and the third section has a toothed surface defined in each one of the two ends thereof, the first toothed surface being matched with the toothed surface of the third section and a screw extending through the first toothed surface and the toothed section of the third section.

4. The wheel chair as claimed in claim 1 wherein a distal end of the second section has a second toothed surface which is matched with the toothed surface of the third section, a screw extending through the second toothed surface and the toothed section of the third section.
